(19) United States
(12) Patent Application Publication
(10) Pub. No.: US 2026/0292081 A1
(43) Pub. Date: Sep. 24, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Natsuki KATAYAMA, Kanagawa (JP)

(73) Assignee: FUJIFILM Business Innovation Corp., Tokyo (JP)

(21) Appl. No.: 19/258,502

(22) Filed: Jul. 2, 2025

(30) Foreign Application Priority Data
Mar. 19, 2025 (JP) 2025-045977

(51) Int. Cl. H04N 1/00

(52) U.S. Cl. CPC H04N 1/0048; H04N 1/00474; H04N 1/00482; H04N 1/00514; H04N 1/00832; H04N 2201/0094

(57) ABSTRACT

An information processing system configures settings for a processing device that is capable of executing a plurality of functions and operates to execute a function selected by a user, and includes a processor configured to: acquire user settings that indicate settings designated by a user and current settings that indicate current settings of the processing device, the user settings and the current settings being settings related to an operation of the processing device; receive selection of a function among the plurality of functions from the user; and in a case where there are settings that are different between the user settings and the current settings and that are prohibited from being changed by the user, when the settings are related to an operation for executing the function selected by the user, notify the user of the settings, and when the settings are not related to the operation for executing the function selected by the user, not notify the user of the settings.

### CROSS-REFERENCE TO RELATED APPLICATIONS

This application is based on and claims priority under 35 USC 119 from Japanese Patent Application No. 2025-045977 filed Mar. 19, 2025.

### BACKGROUND

### (i) Technical Field

The present disclosure relates to an information processing system and a non-transitory computer readable medium.

### (ii) Related Art

Japanese Unexamined Patent Application Publication No. 2018-34303 discloses an image forming device in which each user can set display or non-display for each of a plurality of setting items. When the setting value of a setting item set as non-display by the user is changed (for example, when the setting value of a color mode registered as non-display by the user in advance is full color, but the setting value is changed to monochrome due to running out of color toner), the image forming device notifies the user of the setting item.

### SUMMARY

A plurality of settings related to the operation of a processing device may be designated by a user of the processing device. When there are settings prohibited from being changed by the user among the plurality of settings related to the operation of the processing device, the processing device may operate in a manner unintended by the user since the settings designated by the user are not applied.

To cope with this situation, it is conceivable that, when there are settings that are prohibited from being changed by the user and are different between the settings designated by the user and the current settings, the user is notified of the settings. Such a notification enables the user to easily recognize that the settings designated by the user have not been applied.

A processing device may be capable of executing multiple functions. For example, when the processing device is an image processing device, multiple functions such as printing, scanning, copying, and fax transmission can be executed. The processing device capable of executing multiple functions may have, for each function, a plurality of settings related to the operation for executing the function. Therefore, in the processing device capable of executing multiple functions, the number of settings that can be set by the user may increase.

In the processing device with many settings, if the user is to be notified of settings that are prohibited from being changed by the user and are different between the settings designated by the user and the current settings, a problem may occur in which the number of settings which the user is to be notified of may increase, which is bothersome for the user.

Aspects of non-limiting embodiments of the present disclosure relate to a configuration to, when a user is notified of settings that are prohibited from being changed by the user and are different between the settings designated by the user and the current settings among a plurality of settings related to the operation of a processing device, not provide a notification unnecessary for the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system that configures settings for a processing device that is capable of executing a plurality of functions and operates to execute a function selected by a user, including a processor configured to: acquire user settings that indicate settings designated by a user and current settings that indicate current settings of the processing device, the user settings and the current settings being settings related to an operation of the processing device; receive selection of a function among the plurality of functions from the user; and in a case where there are settings that are different between the user settings and the current settings and that are prohibited from being changed by the user, when the settings are related to an operation for executing the function selected by the user, notify the user of the settings, and when the settings are not related to the operation for executing the function selected by the user, not notify the user of the settings.

### BRIEF DESCRIPTION OF THE DRAWINGS

An exemplary embodiment of the present disclosure will be described in detail based on the following figures, wherein:

FIG. 1 is a schematic diagram of a configuration of a processing system according to the present exemplary embodiment;

FIG. 2 is a schematic diagram of a configuration of a server;

FIG. 3 is a schematic diagram of a configuration of a processing device;

FIG. 4 is a flowchart illustrating a flow of processing performed by the processing device;

FIG. 5 is a first diagram illustrating an example of an initial screen;

FIG. 6 is a diagram illustrating an example of a window of a notification before start of use;

FIG. 7 is a diagram illustrating an example of a cloud connection application screen;

FIG. 8 is a diagram illustrating an example of a window of a notification immediately after login;

FIG. 9 is a second diagram illustrating the example of the initial screen;

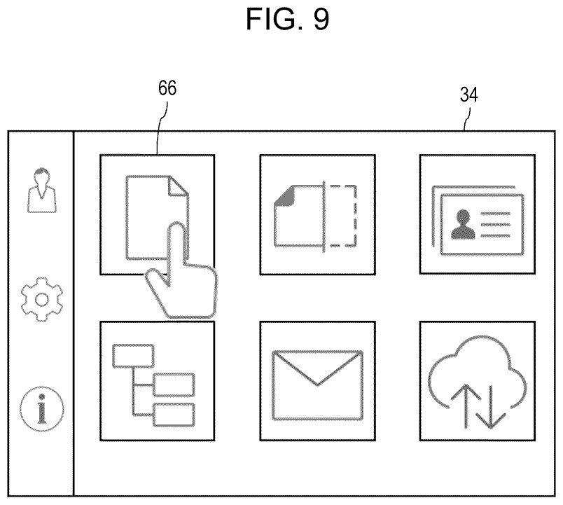

FIG. 10 is a diagram illustrating an example of a window of a function activation notification;

FIG. 11 is a diagram illustrating an example of display of a window of a change prohibition notification;

FIG. 12 is a flowchart illustrating a flow of processing of a notification step;

FIG. 13 is a diagram illustrating a first modification of the function activation notification;

FIG. 14 is a diagram illustrating a second modification of the function activation notification; and

FIG. 15 is a diagram illustrating an example of a collective notification of core settings and function settings.

### DETAILED DESCRIPTION

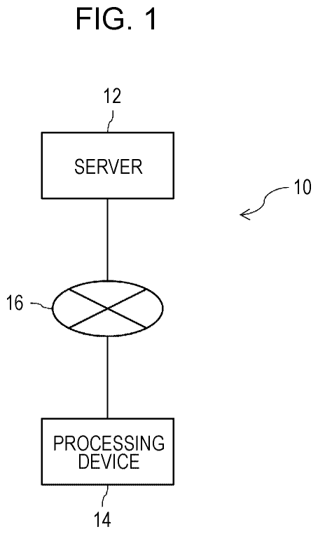

FIG. 1 is a schematic diagram of a configuration of a processing system 10 according to the present exemplary embodiment. The processing system 10 includes a server 12 and a processing device 14. While only one processing device 14 is illustrated in FIG. 1, the processing system 10 may include a plurality of processing devices 14. The server 12 and the processing device 14 are communicably connected to each other via a communication line 16 such as a local area network (LAN) or a wide area network (WAN).

The processing device 14 is capable of executing multiple functions and operates to execute a function selected by a user. In the present exemplary embodiment, the processing device 14 is, but is not limited to, an image forming device such as a multifunction peripheral or a printer. Based on a job input by the user, the processing device 14, which is an image forming device, performs processing related to the job.

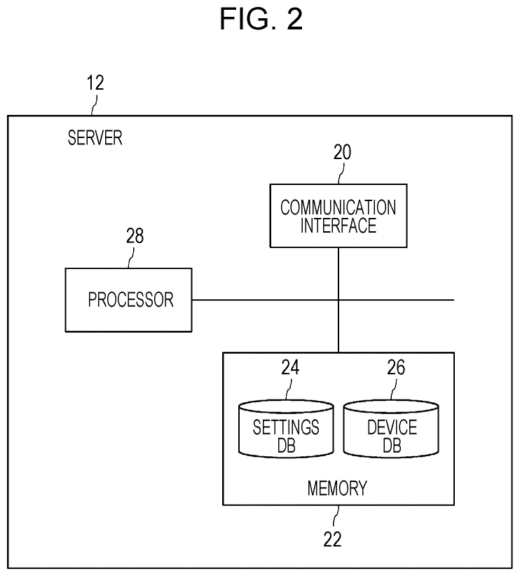

FIG. 2 is a schematic diagram of a configuration of the server 12. For example, the server 12 is composed of a server computer or the like.

For example, a communication interface 20 is composed of a network adapter or the like. The communication interface 20 executes a function of communicating with another device, in particular, the processing device 14, via the communication line 16.

A memory 22 includes a hard disk drive (HDD), an embedded multi media card (eMMC), a read-only memory (ROM), a random-access memory (RAM), or the like. The memory 22 stores a server program for causing each unit of the server 12 to operate. For example, the server program may be stored in a computer-readable non-transitory storage medium such as a Universal Serial Bus (USB) memory or a secure digital (SD) card. A processor 28 can read the server program from such a storage medium and execute the server program.

As illustrated in FIG. 2, the memory 22 stores a settings database (DB) 24 and a device DB 26. The settings DB 24 is a database that stores settings related to the operation of the processing device 14. The settings related to the operation of the processing device 14 include a plurality of setting items and setting values for the respective setting items. The settings of the processing device 14 include a wide variety of settings. In particular, while the processing device 14 is capable of executing multiple functions (for example, a print function, a copy function, a scan function, and the like), the settings related to the operation of the processing device 14 include function settings, which are settings related to the operation for executing the functions, and core settings, which are settings other than the function settings. In a case where the processing device 14 is an image forming device as in the present exemplary embodiment, examples of the function settings include color mode settings related to the print function and copy function, and output file format settings related to the scan function. Examples of the core settings include audit log settings indicating whether an audit log is output, network security settings, system settings (power saving time/report output permission/print prohibition time), and the like.

Desirably, the settings related to the operation of the processing device 14 are stored in the settings DB 24 for each user. In the present exemplary embodiment, the settings related to the operation of the processing device 14 are stored in the settings DB 24 for each company to which a user belongs. For example, the settings for company A, the settings for company B, and the settings for company C are stored in the settings DB 24.

The device DB 26 stores device information related to each processing device 14 included in the processing system 10. The device information includes current settings indicating the current settings of the processing device 14 and information indicating setting items of which the setting values are prohibited from being changed by a user among the setting items of the processing device 14. The server 12 acquires the device information from each processing device 14 by inquiring of the processing device 14, for example, and causes the device DB 26 to store the device information in association with a device ID for identifying the processing device 14.

For example, the processor 28 is composed of a central processing unit (CPU) or the like. The processor 28 is communicably connected to the communication interface 20 and the memory 22 via a data bus. The processor 28 controls each unit of the server 12 according to the server program stored in the memory 22.

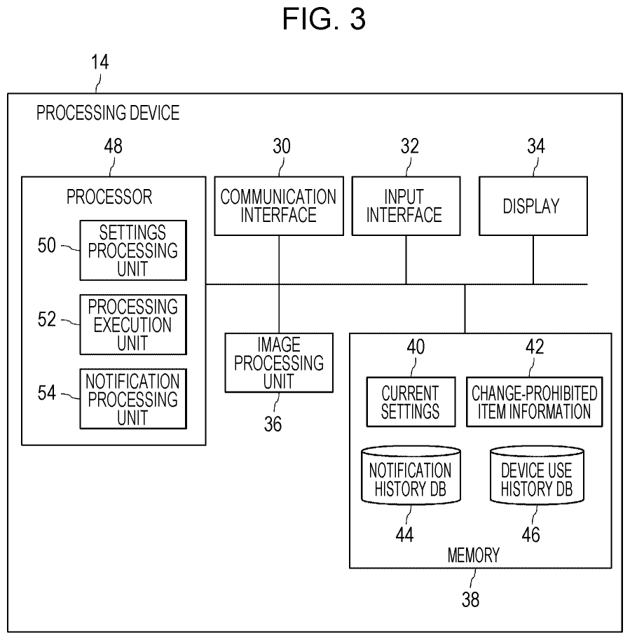

FIG. 3 is a schematic diagram of a configuration of the processing device 14.

For example, a communication interface 30 is composed of a network adapter or the like. The communication interface 30 executes a function of communicating with another device, in particular, the server 12, via the communication line 16.

For example, an input interface 32 is composed of a button, a touch panel, or the like. The input interface 32 is used when a user inputs an instruction to the processing device 14.

For example, a display 34 is composed of a liquid crystal panel or the like. Various screens are displayed on the display 34 in response to an instruction from a processor 48 to be described later.

For example, an image processing unit 36 is composed of a printer unit, a scanner unit, and the like. The image processing unit 36 executes various types of image processing such as print processing, scan processing, and copy processing in response to an instruction from the processor 48.

A memory 38 includes an HDD, an eMMC, a ROM, a RAM, or the like. The memory 38 stores an information processing program for causing each unit of the processing device 14 to operate. For example, the information processing program may be stored in a computer-readable non-transitory storage medium such as a USB memory or an SD card. The processing device 14 can read the information processing program from such a storage medium and execute the information processing program. As illustrated in FIG. 3, the memory 38 stores current settings 40, change-prohibited item information 42, a notification history DB 44, and a device use history DB 46.

The current settings 40 are current settings related to the operation of the processing device 14. The processor 48 to be described later executes processing related to a job in accordance with the current settings 40. As described above, the current settings 40 that are the settings related to the operation of the processing device 14 include a wide variety of setting items and setting values thereof, and include function settings and core settings. In particular, since the processing device 14 can execute multiple functions, the function settings include settings related to each function.

The change-prohibited item information 42 is information indicating setting items of which the setting values are prohibited from being changed by a user (referred to as “change-prohibited items” in the present specification) among the settings related to the operation of the processing device 14. The change-prohibited items include items of which the setting values are prohibited from being changed by an administrator of the processing device 14 and items prohibited due to the capability of the processing device 14 (for example, the setting item “color mode” for the processing device 14 that does not have a color printing function).

In the present exemplary embodiment, in response to the inquiry from the server 12, the processor 48 to be described later transmits the current settings 40 and the change-prohibited item information 42 to the server 12 together with the device ID for identifying the processing device 14. These pieces of information are stored in the device DB 26 as device information.

The notification history DB 44 accumulates and stores notification history information in which a user ID for identifying a user is associated with a settings ID for identifying the settings which the user has been notified of. Methods for acquiring and using the notification history information will be described later.

The device use history DB 46 accumulates and stores device use history information in which a user ID for identifying a user is associated with the number of times of use of the processing device 14 by the user. Methods for acquiring and using the device use history information will be described later.

For example, the processor 48 is composed of a CPU or the like. The processor 48 is communicably connected to the communication interface 30, the input interface 32, the display 34, the image processing unit 36, and the memory 38 via a data bus. The processor 48 controls each unit of the processing device 14 according to the information processing program stored in the memory 38. In particular, the processor 48 executes the functions as a settings processing unit 50, a processing execution unit 52, and a notification processing unit 54.

The settings processing unit 50 changes the settings related to the operation of the processing device 14 (that is, the current settings 40) in response to an instruction from a user. When there is an instruction from the user to change the setting value for a setting item other than the change-prohibited items, the settings processing unit 50 changes the setting value for that setting item. However, when there is an instruction from the user to change the setting value for a change-prohibited item, the settings processing unit 50 does not change the setting value for the change-prohibited item.

The processing execution unit 52 receives selection of a function from a user and executes processing related to a job input by the user. In a case where the job is a print job or a scan job, the processing execution unit 52 causes the image processing unit 36 to execute the processing related to the job. For example, when the user wants to cause the processing device 14 to execute print processing, the user selects a print function from among the multiple functions of the processing device 14. That is, the processing execution unit 52 receives selection of the print function from the user. Thereafter, the processing execution unit 52 causes the image processing unit 36 to execute the processing related to the print job input by the user. In particular, the processing execution unit 52 executes processing of the contents corresponding to the current settings 40.

When the processing related to the job is completed, the processing execution unit 52 causes the device use history DB 46 to store the user ID of the user who has input the job, the processing time of the job, and the device ID of the processing device 14 in association with each other. Accordingly, the device use history DB 46 indicates the number of times of use of the processing device 14 by the user. With the processing time of the job (in other words, the use time of the processing device 14) being stored, the device use history DB 46 also indicates the frequency of use of the processing device 14 by the user.

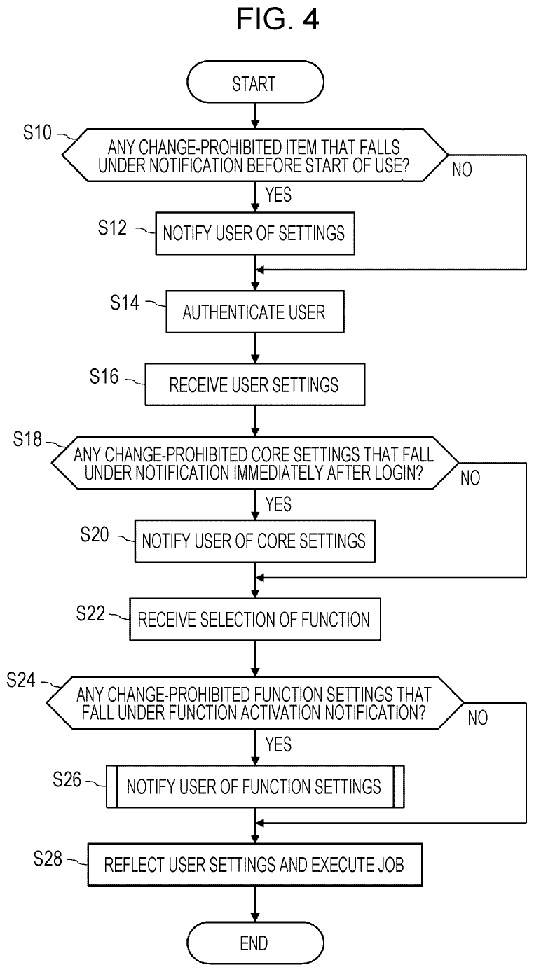

The notification processing unit 54 provides various notifications to a user. In particular, in the present exemplary embodiment, when settings designated by a user to change the current settings 40 (referred to as “user settings” in the present specification) are different from the current settings 40, and those different settings are related to change-prohibited items, the user is notified of the settings. Details of the notification processing performed by the notification processing unit 54 will be described later with reference to a flowchart of FIG. 4.

When the notification processing unit 54 provides a notification to a user, the notification processing unit 54 causes the notification history DB 44 to store notification history information in which the user ID of the user is associated with the settings ID for identifying the settings which the user is notified of.

FIG. 4 is a flowchart illustrating the flow of processing performed by the processing device 14. Hereinafter, with reference to the flowchart, details of the processing performed by the processing device 14 (in particular, the notification processing unit 54) will be described.

A situation is assumed in which the processing device 14 that is an image forming device is installed in a common place such as a co-working space and employees of various companies can use the processing device 14. In particular, in the present example, a case where a user of company B uses the processing device 14 owned by company A will be described as an example.

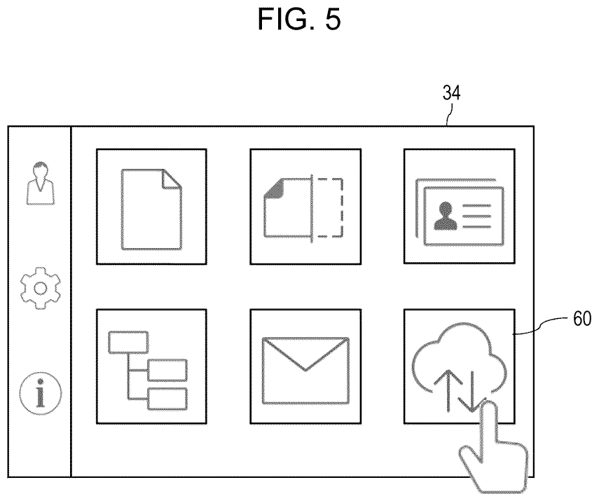

In step S10, the processor 48 causes the display 34 to display an initial screen illustrated in FIG. 5. The user selects a cloud connection application by operating a cloud connection button 60 on the initial screen. The cloud connection application is an application for the processing device 14 to connect to the server 12. When the cloud connection application is selected by the user, the notification processing unit 54 determines whether there is a change-prohibited item that falls under a notification before start of use.

The change-prohibited item that falls under the notification before start of use is a non-changeable setting item that may cause an operation unintended by a user when the user performs a login operation. For example, audit log settings indicating whether an audit log is output, network security settings, or the like correspond to such setting items. Information indicating change-prohibited items that fall under the notification before start of use is stored in the memory 38 in advance. The notification processing unit 54 determines whether there is a change-prohibited item that falls under the notification before start of use based on the information and the change-prohibited item information 42. When there is a change-prohibited item that falls under the notification before start of use, the processing proceeds to step S12. When there is no such change-prohibited item, the processing skips step S12 and proceeds to step S14.

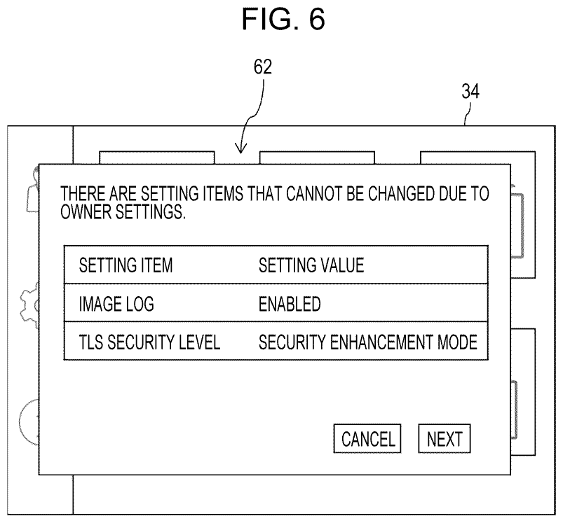

In step S12, the notification processing unit 54 notifies the user of the change-prohibited item that falls under the notification before start of use determined in step S10. In the present exemplary embodiment, as illustrated in FIG. 6, the notification processing unit 54 causes the display 34 to display a window 62 of the notification before start of use. In the window 62 of the notification before start of use, desirably, in addition to the change-prohibited items each determined in step S10 (“image log” and “TLS security level” in the example of FIG. 6), the setting values for the change-prohibited items (“valid” and “security enhancement mode” in the example of FIG. 6) are displayed. The notification processing unit 54 causes the notification history DB 44 to store notification history information in which the user ID of the user is associated with the settings ID of the settings which the user is notified of.

In step S14, the user logs in to the processing device 14 by causing the card reader of the processing device 14 to read an ID card having his/her user ID recorded thereon, for example. From the standpoint of the processor 48 of the processing device 14, the processor 48 authenticates the user. Accordingly, the processor 48 acquires the user ID of the user.

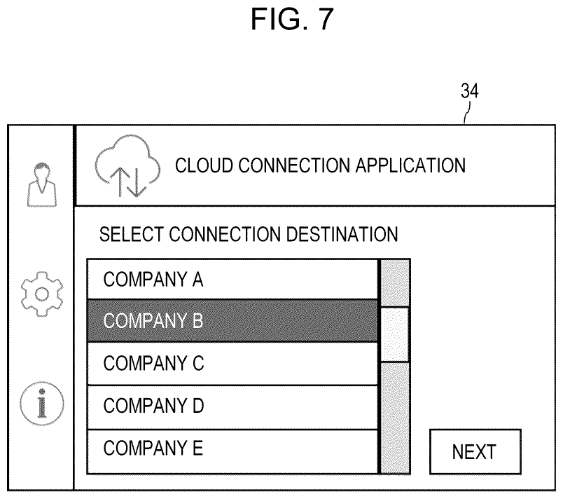

In step S16, the settings processing unit 50 receives user settings from the user. In the present exemplary embodiment, the user inputs the user settings to the processing device 14 by invoking the user settings from the server 12. In response to the operation of the cloud connection button 60 in step S10, the processor 48 causes the display 34 to display a cloud connection application screen illustrated in FIG. 7. On the cloud connection application screen, a list of settings stored in the settings DB 24 of the server 12 is displayed. In the present exemplary embodiment, since settings for each company are stored in the settings DB 24, the settings for each company can be selected on the cloud connection application screen. The settings for each company include core settings and function settings. In particular, the settings for each company include, as function settings, settings for each function that can be executed by the processing device 14. Since the user is an employee of company B, the user logs in to the cloud connection application and then selects the settings for company B. The settings processing unit 50 receives, as the user settings, the setting values for a group of setting items that are the settings for company B.

In step S18, the notification processing unit 54 determines whether there are core settings that fall under a notification immediately after login. The core settings that fall under the notification immediately after login are core settings related to change-prohibited items that are different between the user settings received in step S16 and the current settings 40. The notification processing unit 54 determines whether there are core settings that fall under the notification immediately after login based on the user settings, the current settings 40, and the change-prohibited item information 42. When there are core settings that fall under the notification immediately after login, the processing proceeds to step S20. When there are no such core settings, the processing skips step S20 and proceeds to step S22.

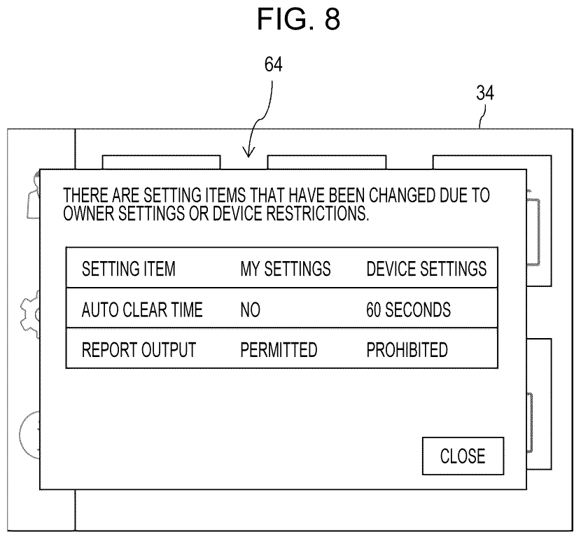

In step S20, the notification processing unit 54 notifies the user of the core settings that fall under the notification immediately after login determined in step S18. In the present exemplary embodiment, as illustrated in FIG. 8, the notification processing unit 54 causes the display 34 to display a window 64 of the notification immediately after login. In the window 64 of the notification immediately after login, desirably, in addition to the setting items of the core settings determined in step S18 (“auto clear time” and “report output” in the example of FIG. 8), the setting values for the setting items of the user settings (“no” and “permitted” in the example of FIG. 8) and the setting values for the setting items of the current settings 40 (“60 seconds” and “prohibited” in the example of FIG. 8) are displayed. The notification processing unit 54 causes the notification history DB 44 to store notification history information in which the user ID of the user is associated with the settings ID of the settings which the user is notified of.

In this way, in the present exemplary embodiment, at a timing after reception of the user settings and before reception of selection of a function of the processing device 14 from the user, a notification is provided for the core settings related to change-prohibited items that are different between the user settings and the current settings 40. At this time, even when there are function settings that are related to change-prohibited items and are different between the user settings and the current settings 40, the notification processing unit 54 does not notify the user of the function settings.

Preferably, the notification processing unit 54 may refer to the device DB 26 stored in the server 12 and notify the user who has been notified of the core settings, of information related to another processing device 14 to which the user settings designated by the user are applicable. This enables the user to easily recognize the presence of another processing device 14 to which the user's own user settings are applicable, and cause that processing device 14 to execute processing related to a job.

In step S22, the processing execution unit 52 receives selection of a function from the user. In the present exemplary embodiment, the processor 48 causes the display 34 to display the initial screen again. Assume that the user selects a copy function by operating a copy application button 66 on the initial screen.

In step S24, the notification processing unit 54 determines whether there are function settings that fall under a function activation notification. The function settings that fall under the function activation notification are function settings that are related to change-prohibited items and to the function received in step S22 and are different between the user settings received in step S16 and the current settings 40. The notification processing unit 54 determines whether there are function settings that fall under the function activation notification based on the user settings, the current settings 40, the change-prohibited item information 42, and the function selected by the user. When there are function settings that fall under the function activation notification, the processing proceeds to step S26. When there are no such function settings, the processing skips step S26 and proceeds to step S28.

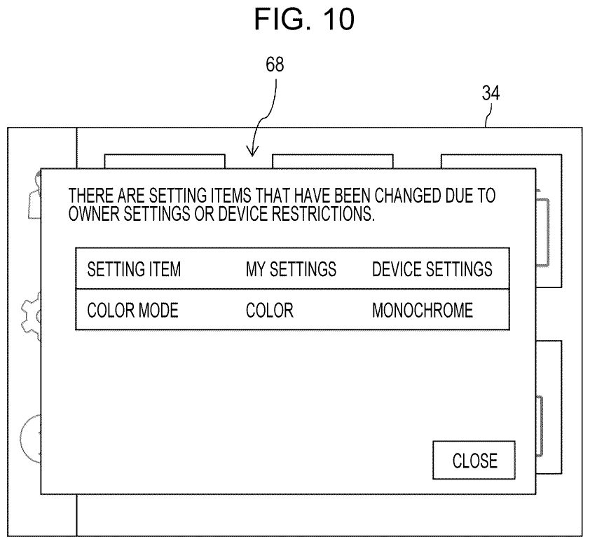

In step S26, the notification processing unit 54 notifies the user of the function settings that fall under the function activation notification determined in step S24. In the present exemplary embodiment, as illustrated in FIG. 10, the notification processing unit 54 causes the display 34 to display a window 68 of the function activation notification. In the window 68 of the function activation notification, desirably, in addition to the setting item of the function settings determined in step S24 (“color mode” in the example of FIG. 10), the setting value for the setting item of the user settings (“color” in the example of FIG. 10) and the setting value for the setting item of the current settings 40 (“monochrome” in the example of FIG. 10) are displayed. The notification processing unit 54 causes the notification history DB 44 to store notification history information in which the user ID of the user is associated with the settings ID of the settings which the user is notified of.

The processing device 14 is capable of executing multiple functions, and the settings of the processing device 14 may include a wide variety of settings related to the multiple functions. If the notification processing unit 54 is to notify the user of the function settings related to all functions of change-prohibited items that are different between the user settings and the current settings 40, the user may be notified of a large number of setting items, and the notification content may become complex.

Therefore, the notification processing unit 54 according to the present exemplary embodiment notifies the user of the function settings related to the operation for executing a function selected by the user, but does not notify the user of the function settings related to the operation for executing a function that is not selected by the user, among the function settings that are related to change-prohibited items and are different between the user settings and the current settings 40. For example, when the user selects the copy function as in the above example, the notification processing unit 54 notifies the user of the function settings related to the copy function, but does not notify the user of the function settings related to the print function and the scan function, among the function settings that are related to change-prohibited items and are different between the user settings and the current settings 40. This is because it is considered unnecessary to provide a notification of settings related to other functions since the user has selected the copy function.

In this way, in the present exemplary embodiment, with regard to function settings that are related to change-prohibited items and are different between the user settings and the current settings 40, the user is not notified of all the setting items, but is notified of only the settings related to a function selected by the user, whereby the number of settings which the user is notified of can be reduced.

As described above, in the present exemplary embodiment, a notification of function settings that are related to change-prohibited items and are different between the user settings and the current settings 40 is provided at a timing after reception of selection of a function of the processing device 14 from the user. At this timing, even when there are core settings that are related to change-prohibited items and are different between the user settings and the current settings 40, the notification processing unit 54 does not notify the user of the core settings again. That is, the notification processing unit 54 notifies the user of the core settings and the function settings in a stepwise manner. This suppresses an increase in the number of settings which the user is notified of at a time, and reduces the complexity of notifications.

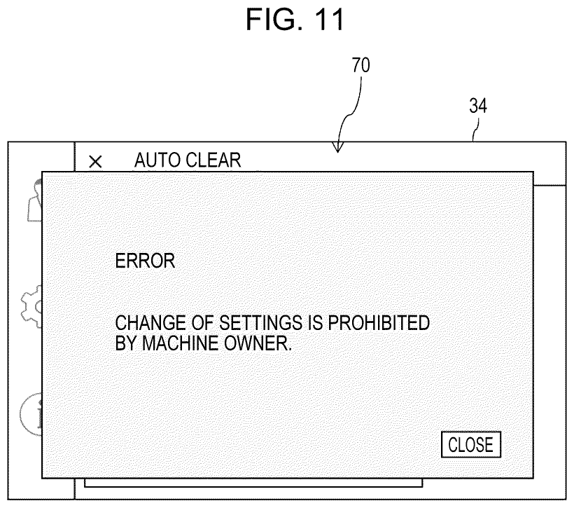

In step S28, for items other than change-prohibited items, the settings processing unit 50 reflects the user settings received in step S16 in the current settings 40. The user may be able to individually change the settings. When the user attempts to change the settings for a change-prohibited item, the notification processing unit 54 desirably notifies the user that the settings attempted to be changed by the user are those for the change-prohibited item. For example, a window 70 of a change prohibition notification illustrated in FIG. 11 is displayed on the display 34.

The processing execution unit 52 executes processing related to the job of the user in accordance with an instruction from the user. When the processing related to the job is completed, the processing execution unit 52 causes the device use history DB 46 to store the user ID of the user, the processing time of the job, and the device ID of the processing device 14 in association with each other.

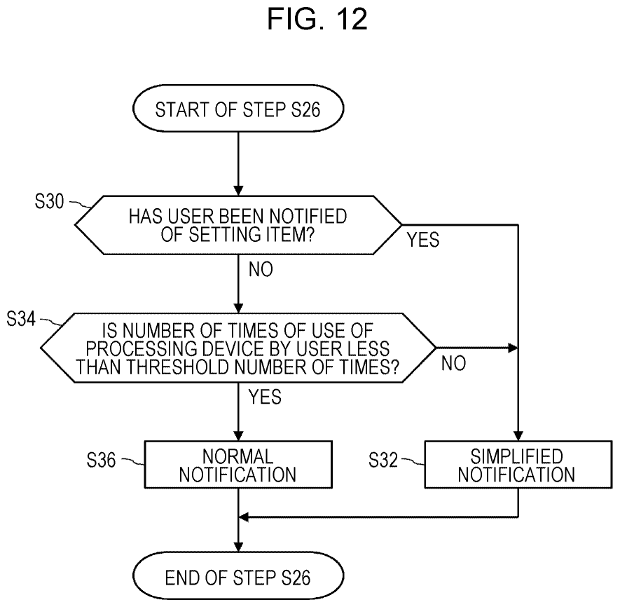

FIG. 12 is a flowchart illustrating a flow of processing of the notification step. Hereinafter, with reference to FIG. 12, details (modification) of the processing of the notification step will be described. Details of step S26 for a notification of function settings will be described.

In step S30, the notification processing unit 54 refers to the notification history DB 44 and determines whether the user has already been notified of the function settings that fall under the function activation notification determined in step S24. When the user has been notified, the processing proceeds to step S32. In step S32, the notification processing unit 54 simplifies the mode of a notification compared to when the user has not been notified of the function settings.

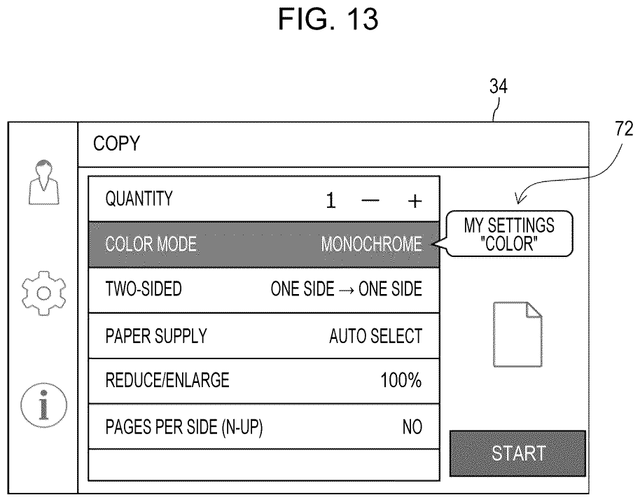

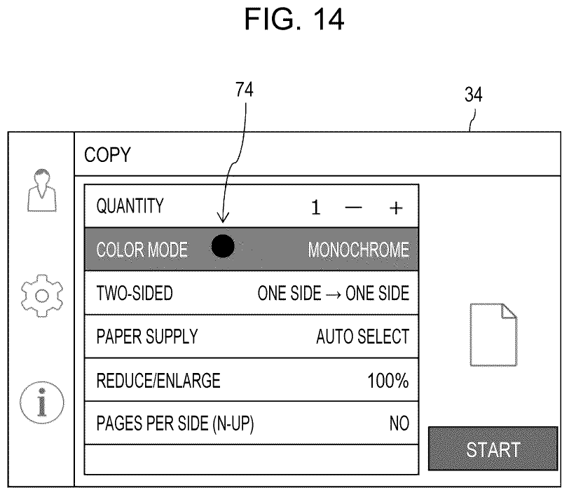

In the present exemplary embodiment, when the user has not been notified of the function settings, the notification processing unit 54 causes the display 34 to display the window 68 of the function activation notification as illustrated in FIG. 10. However, when the user has been notified of the function settings, as illustrated in FIG. 13 for example, the notification processing unit 54 may display a relatively small balloon 72 next to the settings of color mode as a simplified notification on the screen that displays the copy settings, and display the setting value of the user settings within the balloon 72. Alternatively or additionally, the settings of color mode may be displayed in a highlighted manner (in the example illustrated in FIG. 13, in a reversed color). For example, as illustrated in FIG. 14, on the screen that displays the copy settings, a dot 74 may be displayed in the field of the settings of color mode as a simplified notification. Alternatively or additionally, the settings of color mode may be displayed in a highlighted manner (in the example illustrated in FIG. 14, in a reversed color).

Alternatively, when the user has been notified of the function settings, the notification processing unit 54 may refrain from notifying the user of the settings.

In this way, when the user has already been notified of the function settings that fall under the function activation notification, a simplified notification or no notification of the function settings can prevent the repeated notification of similar settings.

Different functions executed by the processing device 14 may have setting items in common (referred to as “common setting items” in the present specification). In other words, a plurality of setting items included in the settings related to the operation of the processing device 14 may include a common setting item that is included in both first function setting items related to the operation for executing a first function among multiple functions and second function setting items related to the operation for executing a second function different from the first function among the multiple functions. In this case, when the user has been notified of the common setting item included in the first function setting items but the user is not yet notified of the common setting item included in the second function setting items, the notification processing unit 54 may refrain from simplifying the mode of the notification of the common setting item included in the second function setting items.

For example, assume that there is a setting item A related to the print function, and there is also the same setting item A related to the copy function. In this case, the setting item A is a common setting item. Assume that the user has already been notified of the setting item A related to the print function. Assume that the function settings that fall under the function activation notification determined in step S24 are the setting item A related to the copy function. In this case, although the user has already been notified of the setting item A, the notification processing unit 54 does not have to simplify the mode of the notification for the setting item A related to the copy function. This is because even with regard to a common setting item, if the functions differ, it may be necessary to provide a notification again.

When it is determined in step S30 that the user has not been notified of the function settings, the processing proceeds to step S34.

In step S34, the notification processing unit 54 refers to the device use history DB 46 and determines whether the number of times of use of the processing device 14 by the user is less than a predetermined threshold. When the number of times of use is less than the predetermined threshold, the processing proceeds to step S36. In step S36, the notification processing unit 54 performs the normal notification, that is, causes the display 34 to display the window 68 of the function activation notification as illustrated in FIG. 10. On the other hand, when the number of times of use is equal to or larger than the predetermined threshold, the processing proceeds to step S32. In step S32, the notification processing unit 54 simplifies the mode of the notification compared to the normal notification or does not provide the notification.

The notification processing unit 54 determines the mode of the notification based on the number of times of use of the processing device 14 by the user in the present exemplary embodiment. Alternatively, in the case where the time at which each user used the processing device 14 is stored in the device use history DB 46 as in the present exemplary embodiment, the notification processing unit 54 may determine the mode of the notification based on the number of times of use per unit time, that is, frequency of use, of the processing device 14 by the user. That is, when the frequency of use is equal to or higher than a threshold, a notification may be simplified or omitted, and when the frequency of use is lower than the threshold, the normal notification may be performed.

While the flowchart of FIG. 12 is an example of the details of step S26, a notification can be simplified or omitted in a similar manner in the notification of the core settings in step S20.

While the exemplary embodiment according to the present disclosure has been described above, the present disclosure is not limited to the above exemplary embodiment, and various modifications can be made without departing from the spirit of the present disclosure.

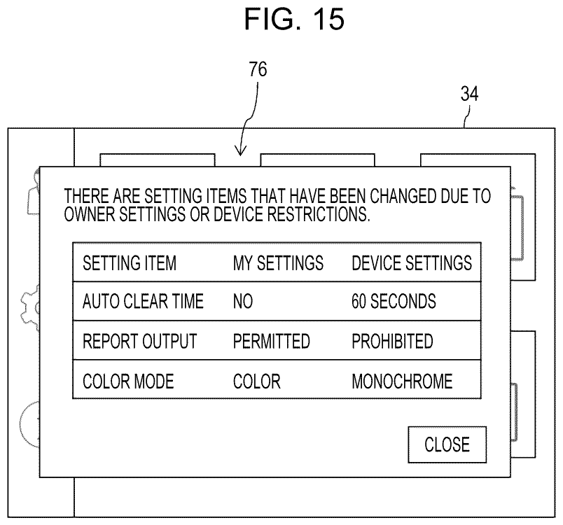

For example, while the user is notified of the core settings and function settings in a stepwise manner by notifying the user of the core settings in step S20 and notifying the user of the function settings in step S26 in the present exemplary embodiment, the user may be notified of such settings in a collective manner. In this case, for example, the notification processing unit 54 causes the display 34 to display a setting notification window 76 illustrated in FIG. 15 that collectively indicates the core settings that fall under the notification immediately after login and the function settings that fall under the function activation notification.

While the user directly operates the processing device 14 in the present exemplary embodiment, the present disclosure is also applicable to a case where the processing system 10 includes a user terminal used by the user and the user configures the settings of the processing device 14 using the user terminal.

Further, while the notification history DB 44 and the device use history DB 46 are stored in the memory 38 of the processing device 14 in the present exemplary embodiment, the notification history DB 44 and the device use history DB 46 may be stored in the memory 22 of the server 12.

In the present exemplary embodiment, each process is executed by any computer. The computer may execute the processes by using a processor serving as hardware, a program serving as software, or a combination of them. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The present disclosure is also applicable to a program and a program product.

### APPENDIX

(((1)))

An information processing system that configures settings for a processing device that is capable of executing a plurality of functions and operates to execute a function selected by a user, comprising a processor configured to: acquire user settings that indicate settings designated by a user and current settings that indicate current settings of the processing device, the user settings and the current settings being settings related to an operation of the processing device; receive selection of a function among the plurality of functions from the user; and in a case where there are settings that are different between the user settings and the current settings and that are prohibited from being changed by the user, when the settings are related to an operation for executing the function selected by the user, notify the user of the settings, and when the settings are not related to the operation for executing the function selected by the user, not notify the user of the settings.

(((2)))

The information processing system according to (((1))), wherein the settings related to an operation of the processing device include function settings and core settings, the function settings being settings related to an operation for executing a function of the processing device, the core settings being settings other than the function settings, and the processor is configured to notify the user of the core settings when there are the core settings that are different between the user settings and the current settings and the user is prohibited from changing the core settings.

(((3)))

The information processing system according to (((2))), wherein the processor is configured to: notify the user of the core settings before selection of the function is received from the user; and notify the user of the function settings related to the function selected by the user after selection of the function is received from the user.

(((4)))

The information processing system according to (((3))), wherein a plurality of processing devices including the processing device are provided, the current settings and device information related to each of the plurality of processing devices are aggregated in a server, the device information indicating setting items of which setting values are prohibited from being changed by a user, and the processor is configured to notify a user who has been notified of the core settings, of information related to another processing device to which the user settings designated by the user are applicable among the plurality of processing devices, based on the device information aggregated in the server.

(((5)))

The information processing system according to (((1))) or (((2))), wherein the processor is configured to notify the user of a setting value of the user settings and a setting value of the current settings for a setting item of the settings that are different between the user settings and the current settings and that are prohibited from being changed by the user.

(((6)))

The information processing system according to (((2))), wherein the processor is configured to: cause a memory to accumulate and store notification history information in which a user ID for identifying a user is associated with a settings ID for identifying settings which the user has been notified of; and refer to the notification history information when a user notification condition is met, and when the user has been notified of the settings, simplify a mode of a notification compared to when the user has not been notified of the settings, or not provide the notification.

(((7)))

The information processing system according to (((6))), wherein a plurality of setting items included in the settings related to an operation of the processing device include a common setting item that is included in both first function setting items and second function setting items, the first function setting items being related to an operation for executing a first function among the plurality of functions, the second function setting items being related to an operation for executing a second function different from the first function among the plurality of functions, and the processor is configured to not simplify the mode of a notification of the common setting item included in the second function setting items when the user has been notified of the common setting item included in the first function setting items but the user has not been notified of the common setting item included in the second function setting items.

(((8)))

The information processing system according to (((1))) or (((2))), wherein the processor is configured to: cause a memory to accumulate and store device use history information in which a user ID for identifying a user is associated with a number of times of use of the processing device by the user: and refer to the device use history information when a user notification condition is met, and when the number of times of use of the processing device by the user is equal to or larger than a predetermined threshold, simplify a mode of a notification compared to when the number of times of use of the processing device by the user is smaller than the predetermined threshold, or not provide the notification.

(((9)))

An information processing program causing a computer that configures settings for a processing device to execute a process, the processing device being capable of executing a plurality of functions and for operating to execute a function selected by a user, the process comprising: acquiring user settings that indicate settings designated by a user and current settings that indicate current settings of the processing device, the user settings and the current settings being settings related to an operation of the processing device; receiving selection of a function among the plurality of functions from the user; and in a case where there are settings that are different between the user settings and the current settings and that are prohibited from being changed by the user, when the settings are related to an operation for executing the function selected by the user, notifying the user of the settings, and when the settings are not related to the operation for executing the function selected by the user, not notifying the user of the settings.

What is claimed is:

1. An information processing system that configures settings for a processing device that is capable of executing a plurality of functions and operates to execute a function selected by a user, comprising
a processor configured to:
acquire user settings that indicate settings designated by a user and current settings that indicate current settings of the processing device, the user settings and the current settings being settings related to an operation of the processing device;
receive selection of a function among the plurality of functions from the user; and
in a case where there are settings that are different between the user settings and the current settings and that are prohibited from being changed by the user,
when the settings are related to an operation for executing the function selected by the user, notify the user of the settings, and
when the settings are not related to the operation for executing the function selected by the user, not notify the user of the settings.

2. The information processing system according to claim 1, wherein
the settings related to an operation of the processing device include function settings and core settings, the function settings being settings related to an operation for executing a function of the processing device, the core settings being settings other than the function settings, and
the processor is configured to
notify the user of the core settings when there are the core settings that are different between the user settings and the current settings and the user is prohibited from changing the core settings.

3. The information processing system according to claim 2, wherein
the processor is configured to:
notify the user of the core settings before selection of the function is received from the user; and
notify the user of the function settings related to the function selected by the user after selection of the function is received from the user.

4. The information processing system according to claim 3, wherein
a plurality of processing devices including the processing device are provided,
the current settings and device information related to each of the plurality of processing devices are aggregated in a server, the device information indicating setting items of which setting values are prohibited from being changed by a user, and
the processor is configured to
notify a user who has been notified of the core settings, of information related to another processing device to which the user settings designated by the user are applicable among the plurality of processing devices, based on the device information aggregated in the server.

5. The information processing system according to claim 1, wherein
the processor is configured to
notify the user of a setting value of the user settings and a setting value of the current settings for a setting item of the settings that are different between the user settings and the current settings and that are prohibited from being changed by the user.

6. The information processing system according to claim 2, wherein
the processor is configured to
notify the user of a setting value of the user settings and a setting value of the current settings for a setting item of the settings that are different between the user settings and the current settings and that are prohibited from being changed by the user.

7. The information processing system according to claim 2, wherein
the processor is configured to:
cause a memory to accumulate and store notification history information in which a user ID for identifying a user is associated with a settings ID for identifying settings which the user has been notified of; and
refer to the notification history information when a user notification condition is met, and when the user has been notified of the settings, simplify a mode of a notification compared to when the user has not been notified of the settings, or not provide the notification.

8. The information processing system according to claim 7, wherein
a plurality of setting items included in the settings related to an operation of the processing device include a common setting item that is included in both first function setting items and second function setting items, the first function setting items being related to an operation for executing a first function among the plurality of functions, the second function setting items being related to an operation for executing a second function different from the first function among the plurality of functions, and
the processor is configured to
not simplify the mode of the notification of the common setting item included in the second function setting items when the user has been notified of the common setting item included in the first function setting items but the user has not been notified of the common setting item included in the second function setting items.

9. The information processing system according to claim 1, wherein
the processor is configured to:
cause a memory to accumulate and store device use history information in which a user ID for identifying a user is associated with a number of times of use of the processing device by the user; and
refer to the device use history information when a user notification condition is met, and when the number of times of use of the processing device by the user is equal to or larger than a predetermined threshold, simplify a mode of a notification compared to when the number of times of use of the processing device by the user is smaller than the predetermined threshold, or not provide the notification.

10. The information processing system according to claim 2, wherein
the processor is configured to:
cause a memory to accumulate and store device use history information in which a user ID for identifying a user is associated with a number of times of use of the processing device by the user; and
refer to the device use history information when a user notification condition is met, and when the number of times of use of the processing device by the user is equal to or larger than a predetermined threshold, simplify a mode of a notification compared to when the number of times of use of the processing device by the user is smaller than the predetermined threshold, or not provide the notification.

11. A non-transitory computer readable medium storing an information processing program causing a computer that configures settings for a processing device to execute a process, the processing device being capable of executing a plurality of functions and for operating to execute a function selected by a user, the process comprising:
acquiring user settings that indicate settings designated by a user and current settings that indicate current settings of the processing device, the user settings and the current settings being settings related to an operation of the processing device;
receiving selection of a function among the plurality of functions from the user; and
in a case where there are settings that are different between the user settings and the current settings and that are prohibited from being changed by the user,
when the settings are related to an operation for executing the function selected by the user, notifying the user of the settings, and
when the settings are not related to the operation for executing the function selected by the user, not notifying the user of the settings.
